(19) United States
(12) Patent Application Publication
(10) Pub. No.: US 2009/0315503 A1
(43) Pub. Date: Dec. 24, 2009

(54) Control device of stepping motor, image reading device, control method and control program of stepping motor

(75) Inventors: Yasuhiko Yoshihisa, Matsurmoto-shi (JP); Hitoshi Igarashi, Shiojiri-shi (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Seiko Epson Corporation, Tokyo (JP)

(21) Appl. No.: 12/454,154

(22) Filed: May 13, 2009

(30) Foreign Application Priority Data
May 12, 2008 (JP) 2008-124371

(51) Int. Cl. G05B 13/02

(52) U.S. Cl. 318/685

(57) ABSTRACT

A method of reading an image by an image sensor comprising: a) reciprocating a carriage from a predetermined position in a predetermined direction by rotating a stepping motor to which a second current value smaller than a first current value is supplied; and b) detecting whether or not the carriage after reciprocating is disposed at the predetermined position, by the sensor, wherein, in the case where the sensor detects that the carriage after reciprocating is disposed at the predetermined position, when the image sensor reads an image, the first current value is supplied to the stepping motor, and in the case where the sensor detects that the carriage after reciprocating is not disposed at the predetermined position, when the image sensor reads an image, a current value obtained by adding a third current value to the first current value is supplied to the stepping motor.

The present application claims the priority based on a Japanese Patent Application No. 2008-124371 filed on May 12, 2008, the disclosure of which is hereby incorporated by reference in its entirety.

### BACKGROUND

1. Technical Field

The present invention relates to a control device of a stepping motor, an image reading device, and a control method and a control program of the stepping motor.

2. Related Art

A so-called image reading device having an image reading function such as a copy machine or a scanner device for reading an image of a sheet surface scans the sheet surface using an image sensor and reads an image from the image sensor. The image sensor is mounted on a carriage, and as the carriage is moved by a carriage transport mechanism having a motor as a drive source, the image sensor can scan the sheet surface.

In a reading operation for the sheet surface, the carriage is moved by the motor, light from a light source provided to the carriage is irradiated to the sheet surface, and the image sensor accumulates light supplied from a light source and reflected from the sheet surface for a predetermined time, converts this into an electrical signal, and transmits the electrical signal as an image signal to an image signal processing unit. In order to move the carriage, a stepping motor or the like is provided, and the stepping motor is driven by a drive current given from a driving circuit. A torque of the stepping motor is set by obtaining a load torque in previous calculation or in actual measurement and in consideration of a change in the load torque, variability between motors, environmental changes, durability, and a margin of error.

A motor torque is, typically, determined so as not to generate a step-out, using build-up factors including a load of an apparatus, variability between apparatuses, variability between motors, variability between drive electricity levels, consideration of an apparatus environment (for example, temperature), durability of the apparatus (secular change or the like), and a margin of error. In addition, a drive current value is set to generate a drive torque allowing for a sufficient margin of error. Typically, the proportion of the part caused by the load of an apparatus is about 39%, the proportion of the part caused by the differences between apparatus loads is about 9%, the proportion of the part caused by the variability between motors is about 9%, the proportion of the part caused by the electrical signal differences is about 11%, the proportion of the part caused by the apparatus environment is about 3%, the proportion of the part caused by the secular change is about 8%, and the proportion of the part caused by the margin of error is about 14%.

However, the drive current value is set to generate excessive torque for a load in consideration of a margin of the load, so that vibration occurs in the stepping motor. For example, when the stepping motor is used for scanning by the carriage of the scanner device, due to the vibration, image deterioration may occur. In addition, motor power consumption increases, and there is a problem in that heat generation of the motor increases.

JP-A-2006-352940 is an example of related art.

It is known that vibration is reduced when the drive current value is reduced. However, there are no proposals on how to set a suitable drive current value to reduce vibration during initial setting or ordinary operations. In addition, there are no proposals on how to set a suitable drive current value in the case where there is increased load due to environmental changes or secular changes.

### SUMMARY

An advantage of some aspects of the invention is that it provides control device and method of a stepping motor, which can reduce vibration of a motor during the initial settings and during ordinary operations.

According to an aspect of the invention, there is provided a motor control circuit for driving a stepping motor and a power controller for providing a drive current value supplied from the motor control circuit. The power controller includes: a unit for detecting a current value right before a step-out occurs in the stepping motor by reducing the drive current value by a predetermined current value unit; a unit for storing the current value right before the step-out occurs as a limit operation current value; and a unit for storing as the drive current value of the stepping motor, a value to which a predetermined current value corresponding to a motor torque added to the limit operation current value is added.

During assembly or initial setting such as factory default setting, a current value of an operation limit can be detected. Therefore, by setting the drive current value to a value obtained by adding a predetermined current value of an added torque to the detected value, the stepping motor can be driven by the minimal current value. Accordingly, vibration of the motor can be reduced. In addition, power consumption and heat generation can also be reduced.

In addition, according to another aspect of the invention, there is provided a control device which gives a drive current value decreased by a unit from the predetermined current unit, periodically or while a load is small, to the limit operation current value of the stepping motor to drive the stepping motor, during the ordinary operation, and increases the drive current value when a step-out occurs.

In ordinary operations, the limit operation current value, used so as not to automatically generate a step-out, is checked to enable the stepping motor to be operated at the smallest drive current value. Accordingly, vibration of the motor can be reduced, and power consumption and heat generation can also be reduced. In addition, without the need for manual operations, an optimal drive torque can be generated, although a needed torque is changed due to environmental changes or secular changes. In addition, when the required load torque is increased, the set drive current can be increased to operate the apparatus without the step-out.

In addition, it is advantageous that the predetermined current value corresponding to the added motor torque can be increased when the step-out occurs in an ordinary operation.

When the load increases during ordinary operations, by setting the drive current value by adding an added current value to be added to the operation limit current value as a large value, the apparatus can be operated by a small current value without the step-out during a practical operation, thereby enabling a reduction in the vibration. In addition, when the load is changed, an optimal drive current value can be automatically set.

In addition, it is preferable that the drive current value have an upper limit. Considering the heat generation of the stepping motor, in the case where the drive current value is increased, by providing the limit, errors caused by the heat generation of the motor can be prevented.

In addition, the current value right before a step-out occurs may be detected at a rotation speed of 2 or higher. Due to the rotation speed of the stepping motor, the motor torque is changed, and the load is changed, so that the necessary drive current is also changed. Therefore, the current value right before the step-out occurs may be measured at a rotation speed of 2 or higher.

In addition, the control method of the stepping motor of this aspect of the invention, which supplies a drive current to the stepping motor to drive the stepping motor, includes: detecting a current value right before a step-out occurs in the stepping motor by reducing the drive current value by a predetermined current value unit; storing the current value right before the step-out occurs as a limit operation current value; and storing as the drive current value of the stepping motor, a value to which a predetermined current value corresponding to a motor torque added to the limit operation current value is added.

Accordingly, the stepping motor can be driven by a reduced drive torque, so that vibration can be reduced, and heat generation and power consumption can also be reduced.

In addition, the control method of the stepping motor, gives a drive current value decreased by a unit from the predetermined current unit, periodically or while a load is small, to the limit operation current value of the stepping motor to drive the stepping motor, during the ordinary operation, and increases the drive current value when a step-out occurs.

Accordingly, when a user uses the apparatus, an optimal drive current corresponding to the load can be automatically checked and set, so that it is possible to drive the apparatus with an optimal drive current and reduced vibration although there is changed load due to environmental changes and the secular changes.

In addition, the invention can also be embodied as a computer program for controlling the stepping motor, a computer program for implementing the above-mentioned image reading device, and a recording medium in which the computer programs are recorded. The computer program can be installed in an information processing device to execute the functions of the above-mentioned control device and method of the stepping motor.

### BRIEF DESCRIPTION OF THE DRAWINGS

The invention will be described with reference to the accompanying drawings, wherein like numbers reference like elements.

FIG. 1 is a perspective view illustrating an outer appearance of a scanner device according to an embodiment of the invention.

FIG. 2 is a view schematically illustrating an inner configuration of the scanner device illustrated in FIG. 1.

FIG. 3 is a circuit block diagram illustrating an electrical configuration of the scanner device illustrated in FIG. 1.

FIG. 4 is a block diagram illustrating a configuration of a motor control unit according to the embodiment of the invention.

FIG. 5 shows tables of current used for measurement of a drive current of a stepping motor according to the embodiment of the invention.

FIG. 6 is a flowchart for explaining operations of process measurement of a drive current value of the stepping motor according to the embodiment of the invention.

FIG. 7 is a chart for explaining checking and setting of the drive current in operations of the process measurement.

FIG. 8 is a flowchart for explaining operations of ordinary measurement of the drive current value of the stepping motor according to the embodiment of the invention.

FIG. 9 is a chart for explaining checking and setting of the drive current in operations of ordinary measurement.

### DESCRIPTION OF EXEMPLARY EMBODIMENTS

Hereinafter, exemplary embodiments of the invention will be described with reference to the accompanying drawings.

### External Configuration of Scanner Multi-Function Device

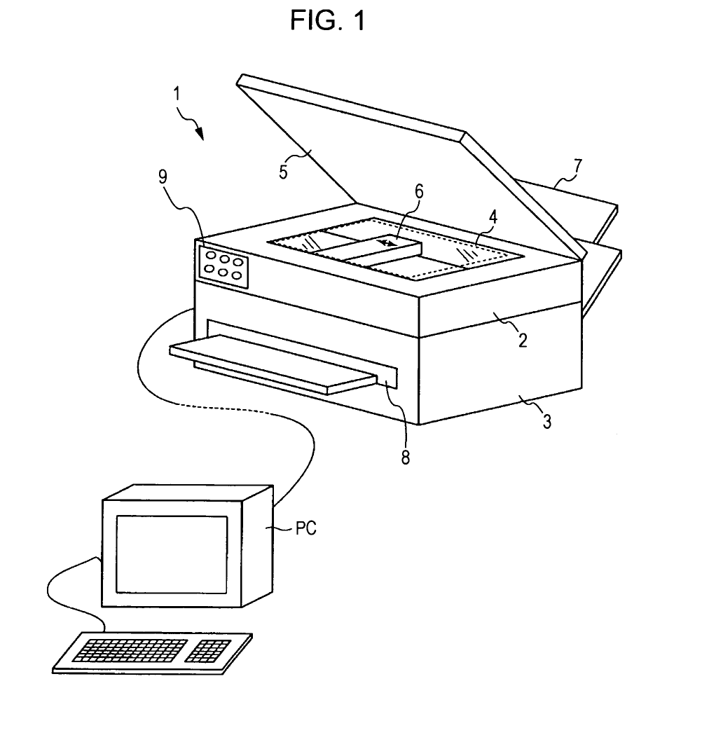

FIG. 1 is a perspective view illustrating an external appearance of a scanner multi-function device 1 as an image reading device according to an embodiment of the invention. The scanner multi-function device 1 includes a scanner section 2 and a printer section 3 and is configured as a so-called multi-function device having a copying function and a printing function in addition to a scanning function. Specifically, the scanner multi-function device 1 is connected to a personal computer PC (hereinafter, simply called a PC) to output image data read by the scanner section 2 to the PC, or by transmitting image (printing) data from the PC to the scanner multi-function device 1, enables the printer section 3 to perform printing on the basis of the image (printing) data. In addition, the scanner multi-function device 1 transmits image data read by the scanner section 2 to the printer section 3 directly or through the PC to perform printing, thereby functioning as a copy machine.

The scanner section 2 includes a platen 4 which is made of a transparent plate body such as a glass plate and on which a sheet is placed, a sheet cover 5 for covering the sheet placed on the platen 4, and various internal mechanisms such as a carriage 6 described later. The printer section 3 includes a printing unit not shown therein to enable the printing unit to perform printing on a printing paper supplied from a feeding mechanism 7 fitted on a rear side of the scanner section 2, and includes a discharge unit 8 fitted on a front side of the scanner section 2 to discharge the printing sheet. In addition, the scanner multi-function device 1 is provided with operation buttons 9 to select functions of the scanner multi-function device 1 or commands operations of the scanner multi-function device 1.

### Internal Configuration of Scanner Device

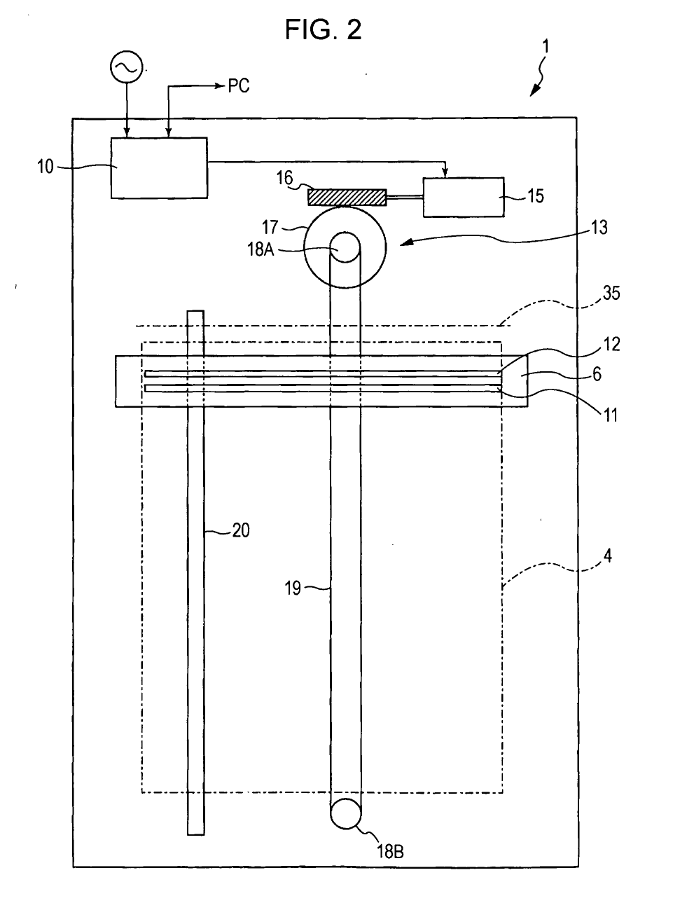

FIG. 2 is a view illustrating a schematic configuration of the scanner section 2 in the scanner multi-function device 1 according to the embodiment. As illustrated in FIG. 2, the scanner multi-function device 1 includes a control circuit 10, a carriage 6 to which an image sensor 11 is mounted, a carriage transport mechanism 13 for transporting the carriage 6, and the like. In addition, the control circuit 10 controls the scanner section 2 and also functions as a controller for a printing function and a copying function.

The carriage transport mechanism 13 includes a stepping motor (ST motor) 15 as a driving source, a worm gear 16 joined to the stepping motor 15, a spur gear 17 engaged with the worm gear 16 to rotate at a predetermined reduction ratio, a pulley 18A joined to the spur gear 17, a pulley 18B positioned to oppose the pulley 18A with the platen 4 interposed therebetween, a timing belt 19 extending between the pulleys 18A and 18B, a guide shaft 20 extending along the extension direction of the timing belt 19, and the like. In the following description, a direction from the pulley 18A to the pulley 18B is referred to as forward (front side), and the opposite direction is referred to as backward (rear side).

The timing belt 19 is propelled by a driving force of the stepping motor 15 through the worm gear 16, the spur gear 17, and the pulley 18A. A portion of the timing belt 19 is fixed to the carriage 6. In addition, the carriage 6 is slidably connected to the guide shaft 20. Therefore, as the timing belt 19 is propelled by driving the stepping motor 15, the carriage 6 is moved along the guide shaft 20.

To the carriage 6, the image sensor 11 is mounted as described above. A sheet surface of a sheet placed on the platen 4 is irradiated with illumination light from an LED array 12, and the illumination light reflected from the sheet surface is received by the image sensor 11. Charges based on an image of the sheet surface are accumulated in the image sensor 11, and an electrical signal based on the charge quantity is output from the image sensor 11.

### Electrical Configuration of Scanner Device

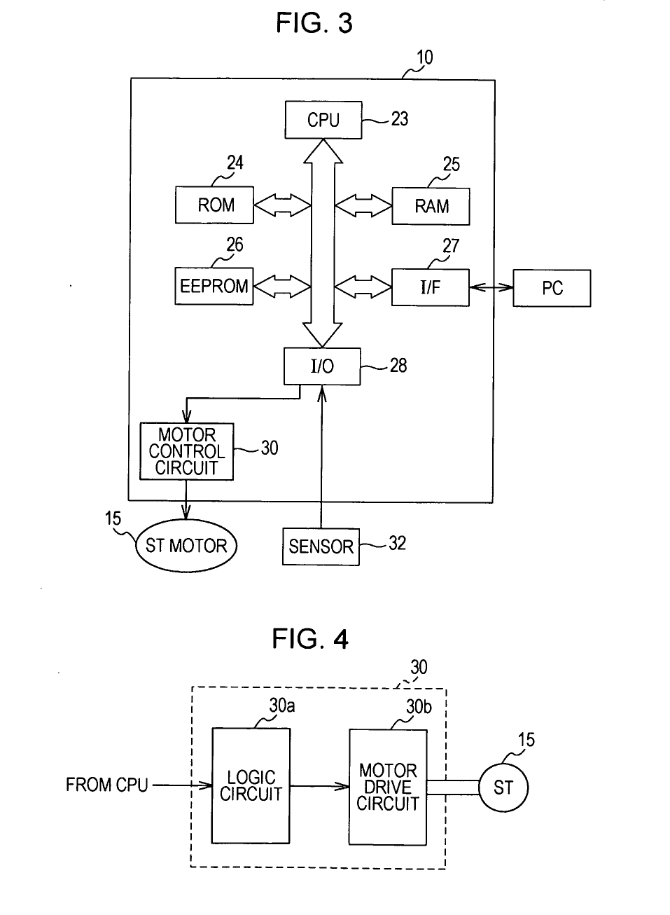

FIG. 3 is a circuit block diagram illustrating an electrical configuration of the scanner multi-function device 1 according to the embodiment. As illustrated in FIG. 3, the control circuit 10 includes a central processing unit (CPU) 23, as a memory, a read-only memory (ROM) 24, a random-access memory (RAM) 25, an electrically erasable and programmable read-only memory (EEPROM) 26, an external interface (I/F) 27 having a USB interface or the like for connecting the scanner multi-function device 1 to a PC, an input/output port (I/O) 28, and a motor control circuit 30 for supplying a drive signal to the stepping motor 15. The input/output port 28 is connected to an external sensor 32 to receive an output of the sensor 32 and outputs control data for the stepping motor 15 to the motor control circuit 30.

The CPU 23 executes various operating units according to programs stored in the ROM 24 and the EEPROM 26 and controls each unit including the stepping motor 15 of the device.

The ROM 24 is a semiconductor memory storing various programs executed by the CPU 23 or various types of data. The ROM 24 stores programs for measuring and setting a drive current value of the stepping motor 15 operated by the CPU 23 described later and can control the stepping motor 15 by executing the corresponding program.

The RAM 25 is a semiconductor memory for temporarily storing programs to be executed by the CPU 23 or data. As the program stored in the ROM 24 is read to the RAM 25 and executed, the drive current value of the stepping motor 15 described later can be measured or set, thereby controlling the stepping motor 15.

The EEPROM 26 is a semiconductor memory for storing predetermined data of operational results of the CPU 23, the ROM 24, the RAM 25, and the like, and maintaining the data after power of the scanner multi-function device is turned off. In this embodiment, the drive current value for driving the stepping motor 15 is stored.

The external interface 27 is a unit for properly converting data into suitable formats during the exchange of information with the PC.

The motor control circuit 30 controls a rotation speed and the number of rotations of the stepping motor 15 by controlling a drive current applied to the stepping motor 15 on the basis of a control signal from the CPU 23. In addition, for the control circuit 10, the PC may be used. In addition, the sensor 32 is used for detecting a mark of a home position 35 of the carriage 6, however, may also function as the image sensor 11.

FIG. 4 is a block diagram illustrating a configuration of the motor control circuit 30. As illustrated in FIG. 4, the motor control circuit 30 includes a logic circuit 30a and a motor driving circuit 30b as a control circuit of the stepping motor 15. The logic circuit 30a inputs setting data from the CPU 23 to set an operation environment and controls the driving circuit 30b depending on driving data supplied from the CPU 23. The driving circuit 30b performs switching of a direct current on the basis of control of the logic circuit 30a and supplies an excitation current to the stepping motor 15 to drive this.

### Measurement Operation of Drive Current of Stepping Motor

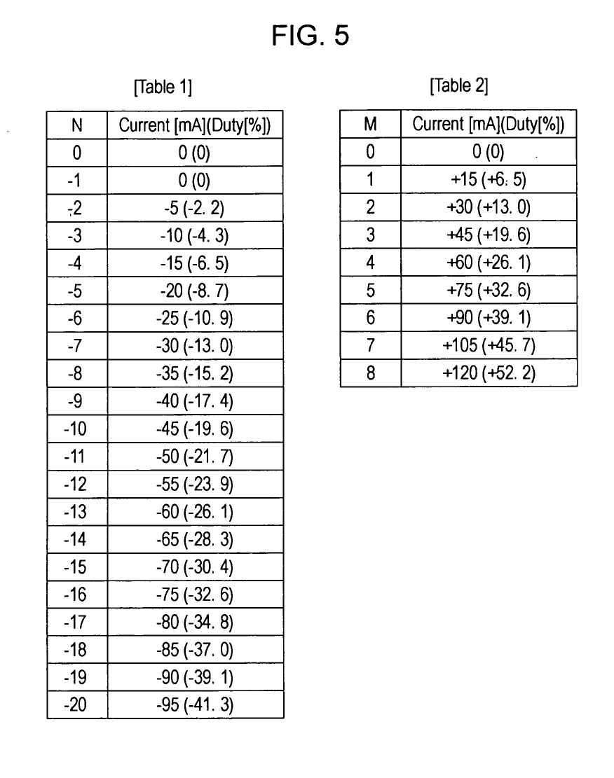

Next, with reference to FIGS. 5 to 9, measurement and setting of the drive current of the stepping motor 15 in the scanner multi-function device having the above-mentioned configuration will be described. In the description, as a carriage motor, the stepping motor 15 is exemplified. However, this can be applied to control of other stepping motors.

FIG. 5 shows current value tables used for operations for setting the drive current value by checking an operation limit current value right before a step-out of the stepping motor 15 occurs. Table 1 of FIG. 5 shows a current value table used in the case of reducing the drive current value in steps of 5 mA units whereby, N is represented in units of “−5 mA”. By reducing the value of N, the drive current value supplied to the stepping motor 15 is reduced. In addition, Table 2 of FIG. 5 shows a current value table for motor torque addition, showing current values added to the checked operation limit current value in terms of motor torque corresponding to an environmental change and a secular change, and the motor torque-added current value is denoted by M. Tables 1 and 2 are stored in the ROM 24, and whenever the operation limit current value is checked, the values of N and M are stored in the EEPROM 26.

As the operations of checking the operation limit current value, there are process measurement operations performed during assembly, factory default setting, or the like, that is, during initial setting, and ordinary measurement operations performed when a user uses the scanner multi-function device. The process measurement is an operation of checking the operation limit current value during assembly, factory default setting, or the like, and is a checking operation of detecting whether or not a step-out occurs by reducing the drive current and driving the stepping motor 15 and setting the operation limit current value to the last maximum value that will not cause a step-out. In addition, in the ordinary measurement operations, when the user uses the scanner multi-function device, the drive current supplied to stepping motor 15 is reduced to check whether or not a step-out occurs after a predetermined number of sheets, or a predetermined period, or during an idle state. This operation checks whether or not the drive current is suitable and changes the drive current when the set drive current is too low.

### Description of Process Measurement

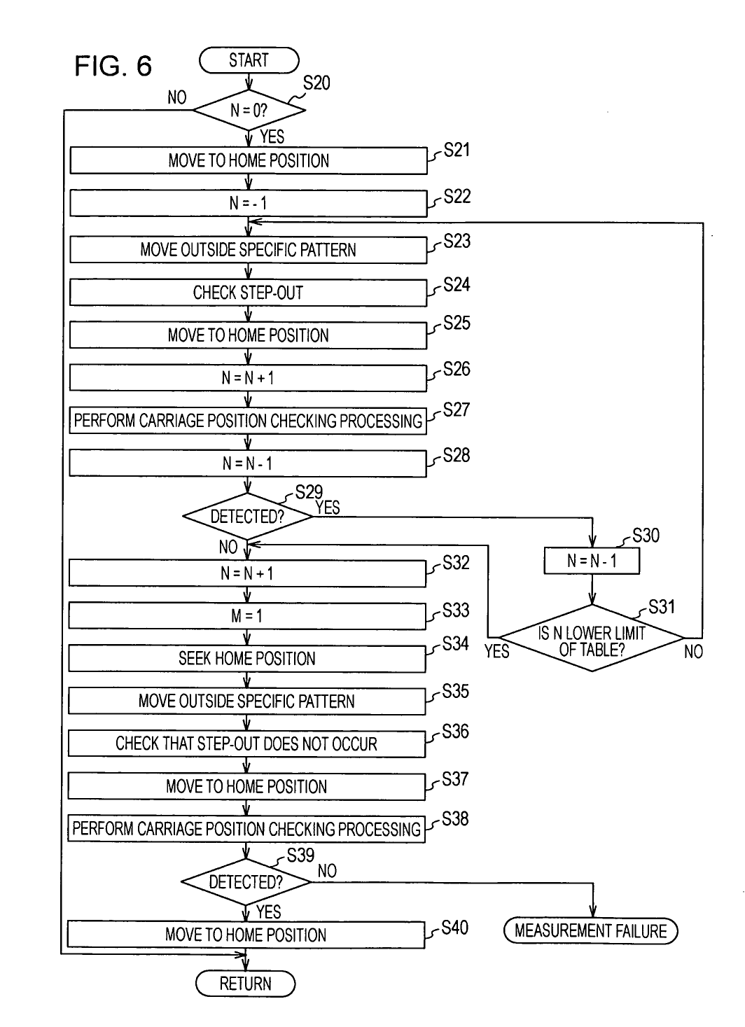

Next, the operations of the process measurement will be described with reference to a flowchart of FIG. 6. The process measurement is performed once during assembly or factory default setting for checking the last operation limit current value before a step-out occurs. The flowchart of FIG. 6 explains operations of detecting whether or not a step-out occurs in the stepping motor 15 used as the carriage motor.

First, Table 1 which is the current value table is acquired from the EEPROM 26 to check whether or not N is “0” (Step S20). When N is “0”, this means that the process measurement is not terminated. Thereafter, the carriage 6 is moved to the home position 35 (Step S21). The home position is an original position of the carriage in FIG. 2, and the position is denoted by reference numeral 35.

Therefore, first, N is assumed to “−1”, and the drive current value is set to a value decreased by “5 mA” to update the value of the EEPROM 26 where the drive current value is stored. Thereafter, by supplying a drive signal of a predetermined step, the carriage 6 is moved to a position different from the original position (Step S23). The movement of the carriage 6 to a position is to move the carriage 6 outside a specific pattern (for example, marking of the original position) representing the original position. Thereafter, by supplying a step current at a predetermined frequency, the stepping motor 15 is driven at a predetermined rotation speed (Step S24). The predetermined rotation speed may be 651 pps (pulse/sec) which allows for a resolution of 300 dpi×300 dpi that is frequently used for reading by a general user. The stepping motor 15 is driven at the predetermined rotation speed to check whether a step-out will occurs after the drive current value has been lower. After moving the carriage 6 in Step S24, the carriage 6 is moved to the home position 35 (Step S25), the value of N of the EEPROM 26 is updated to N+1 (Step S26), and checking of the carriage position is performed (Step S27). This is performed to check the mark of the original position (home position). Thereafter, the value of the EEPROM 26 is updated to N−1 (Step S28), and determining whether or not the mark of the original position could be detected is performed (Step S29). Here, in the case where the mark of the original position cannot be confirmed (in the case of No), it is determined that a step-out has occurred. In the case where the step-out does not occur (Yes), the drive current value is additionally reduced by a unit (5 mA) (Step S30), and determining whether or not the value of N is the lower limit of Table is performed (Step S31). When it is determined that the value of N is not the lower limit (in the case of No), operations from Step S23 to Step S28 are repeated until the step-out occurs. In addition, when it is determined that the value of N is the lower limit in Step S31 (in the case of Yes), Step S32 is performed.

In the case where the step-out is detected, the drive current value is set to N+1, and by using as the operation limit current value a value obtained by increasing the drive current value by a unit, the stored value of the EEPROM 26 is updated (Step S32). Next, as a motor torque addition due to an environmental change, a secular change, and the like, a value (+15 mA) of Ml is added to drive the stepping motor 15, and an operation of checking whether or not the carriage 6 is normally driven is performed. This refers to operations from Step S33 to Step S40, and this is the same as the operations from Step S23 to Step S29 excluding Step S28. Accordingly, a description of each of the steps will be omitted. Specifically, similarly to the operations of checking whether or not a step-out occurs by decreasing the drive current, the home position 35 is sought, and the stepping motor 15 is driven at 651 pps and moved to the home position 35 to perform checking of the carriage position, thereby checking whether or not it is normally operated by the drive current value obtained by adding +15 mA as the additional motor torque M to the operation limit drive current value.

By the process measurement, the drive current value obtained by adding the minimum additional motor torque M to the operation limit current value right before the step-out occurs is set in the EEPROM 26, and by the drive current value, the stepping motor 15 is driven. Since the stepping motor 15 is driven by the drive current value obtained by adding the minimum value as the additional motor torque M to the current value right before the step-out occurs, it can be driven by the lowest drive current value, and vibration can be reduced. In addition, power consumption can also be reduced, so that heat generation can be reduced.

In addition, in the case where the detection was possible in Step S39 (in the case of Yes), the carriage 6 is moved to the home position 35 (Step S40), and a series of operations are terminated. In the case where the detection is impossible in Step S39 (in the case of No), measurement failure is determined.

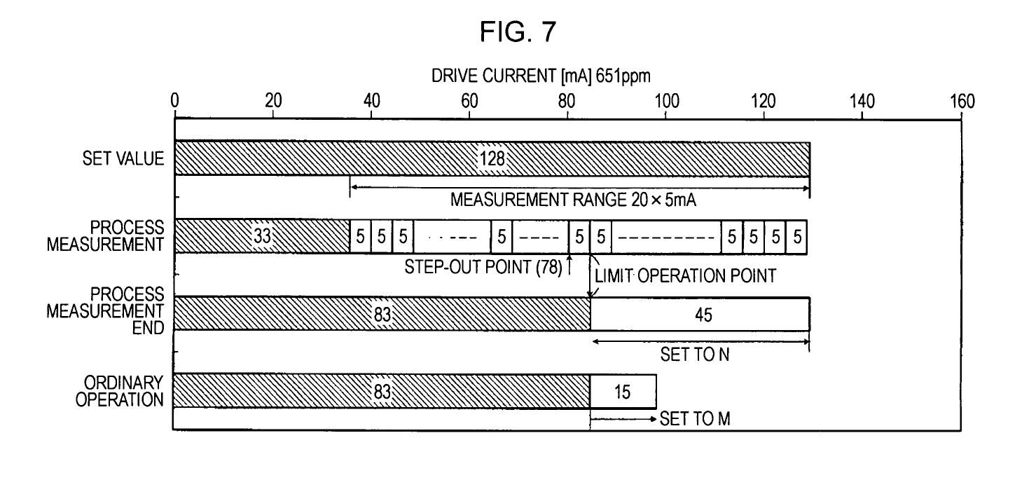

FIG. 7 is a chart for explaining setting of the drive current value in the process measurement. As N, the range of measurement in units of 5 mA is set to the range of 20×5 mA, in order to initially detect the operation limit current value before the process measurement, the setting value is set to 128 mA, and the drive current N is set by subtracting “5 mA” from the set value to generate a step-out. The current value right before a step-out occurs is set to the limit operation current value. In addition, it is represented that the drive current value is set to a value obtained by adding Ml (+15 mA) as the additional motor torque to the limit operation current value. As described above, by checking the limit operation current value during assembly or factory default setting, the drive current value for generating an optimal torque is set for operation.

### Description of Operation of Ordinary Measurement

Next, when the user uses the scanner multi-function device, ordinary measurement operations for setting a suitable drive current value will be described.

As mechanical factors, a load is gradually increased due to the secular changes. In addition, the load on the motor changes due to environmental changes. Typically, when the drive current value set during the initial setting is used as it is, and the load increases over its limit, a step-out occurs. Accordingly, in an ordinary operation, the operation limit current value is checked, and when the step-out occurs, the drive current value needs to be adjusted. As described above, the operation limit current value or the value of the additional motor torque needs to be automatically adjusted according to the secular changes or environmental changes. For example, when the load increases due to the secular change, the drive current value needs to be set to a higher value. In addition, since the load on the device is changed due to the environmental change, the drive current value changed due to the environmental change needs to be set to a suitable drive current value. Ordinary measurement described later is an operation for automatically setting the optimal drive current value as the load is changed due to the environmental change that occurs during the use or the secular change. In addition, the ordinary measurement also means checking whether or not a suitable drive current value is set when the apparatus is used.

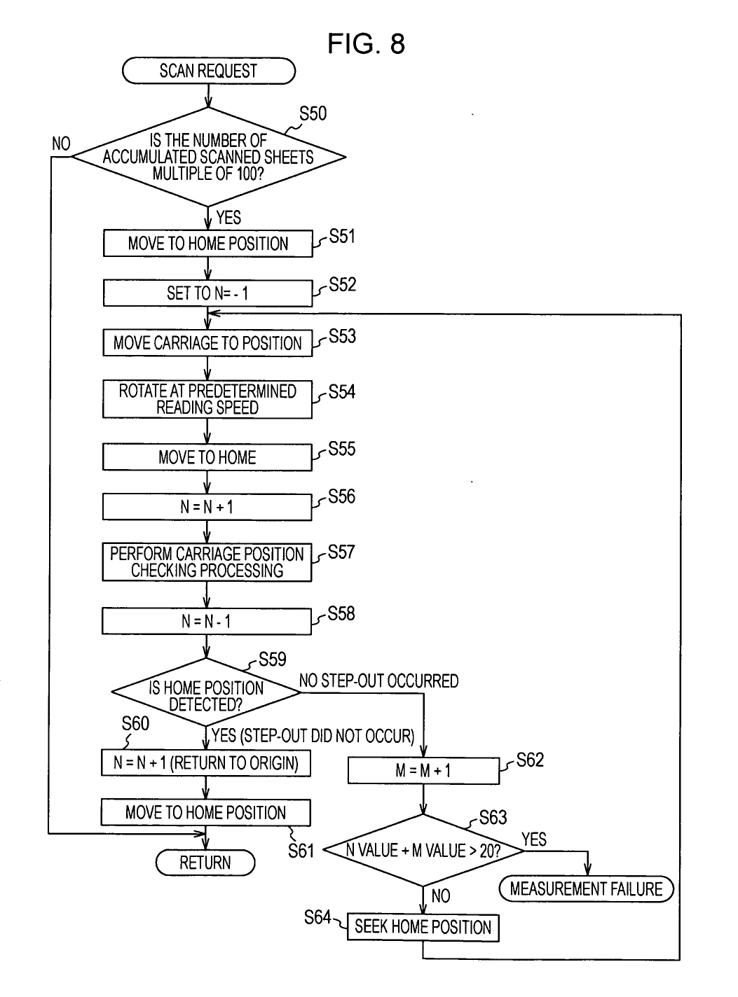

FIG. 8 is a flowchart for explaining the operation of the ordinary measurement.

The ordinary measurement is performed periodically, for example, performed whenever the number of scanned sheets is 100 (Step S50). When the number of scanned sheets reaches 100 (in the case of Yes), the carriage 6 is moved to the home position 35, and an operation of checking the set drive current value is started (Step S51). The ordinary measurement operation of checking the drive current value is performed in an idle state where the load of the device is small. The idle state means during a power saving operation, cleaning, or the like.

In Step S51, after moving the carriage 6 to the home position 35, the value of N is set to N−1, and the drive current value stored in the EEPROM 26 is updated (Step S52). Specifically, by using a value obtained by subtracting 5 mA (−5 mA) from the set limit operation current value, similarly to the process measurement, the carriage 6 is moved to a position (Step S53), and the stepping motor 15 is rotated at a rotation speed (651 pps in the case of 300 dpi×300 dpi) which is the same as that in the process measurement (Step S54). Thereafter, by checking the carriage position by moving the carriage 6 to the home position 35, whether or not a step-out occurs is confirmed (Steps S55 to S59). When the step-out does not occur (in the case of Yes in Step S59), it is determined that a suitable drive current value is set, and the value of N is returned to its original value (N=N+1) to return the drive current value stored in the EEPROM 26 to its original value (Step S60). In addition, the carriage 6 is moved to the home position 35 (Step S61), and the ordinary measurement operation is terminated.

Here, when the drive current value N is decreased by a grade, in the case of a step-out (No is determined in Step S59), the value of the additional motor torque M of Table 2 of FIG. 5 is set to M+1. Specifically, when the value of the additional motor torque M set in the process measurement is +15 mA, the value of M is changed to +30 mA (Step S62), and checking whether or not a step-out occurs is performed again. In addition, after the re-checking, when the step-out does not occur, the value of the increased additional motor torque M is set to the drive current value as it is.

In addition, the drive current value that can be increased as the drive current has an upper limit due to heat generation, and it is determined whether or not the sum of N and M after Step S62 exceeds 20 (Step S63). In addition, in the case where the sum of N and M exceeds 20 (in the case of Yes), it is determined that it exceeds the heat generation limit, and it is removed from the operation flow of the ordinary measurement (corresponding to measurement failure). In this case, processing such as giving warning is performed. In addition, in the case where the sum of N and M does not exceed 20 in Step S63 (in the case of No), a detection operation of the home position 35 is performed (Step S64), and the process returns to Step S53 again.

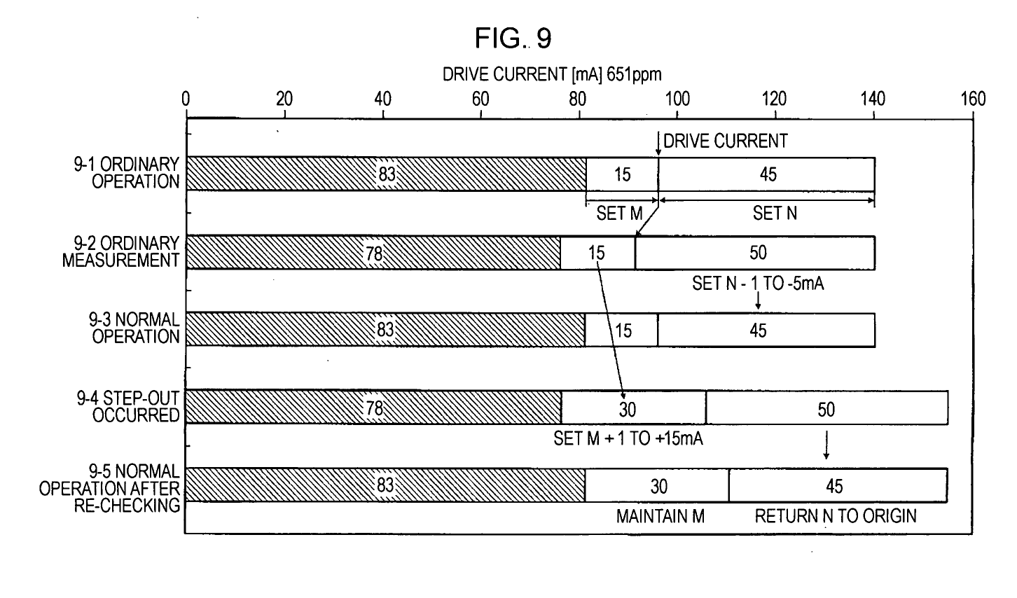

FIG. 9 explains checking and setting of the drive current in the ordinary measurement. An ordinary reading operation in which the operation limit current value is set to 83 mA, the additional motor torque M is set to +15 mA, and the drive current value is set to 98 mA to perform the ordinary operation is shown (graph 9-1). In addition, in the ordinary measurement, the operation limit current value is set to 78 mA by subtracting 5 mA, that is, decreasing N by 1, the additional motor torque is set to 15 mA, and therefore the sum is 93 mA. By the sum, the stepping motor 15 is driven to check whether or not a step-out occurs. This refers to a graph 9-2. When the step-out does not occur, the value of N is returned to its original value, and the operation limit current value is returned to 83 mA as the original drive current value set in the EEPROM 26 (graph 9-3).

When the operation limit current value is decreased for driving in the ordinary measurement operation, in the case of the step-out, the value of the additional motor torque M is increased by 1 to +30 mA, and the operation limit current value is reduced by 5 mA, thereby performing re-checking (graph 9-4). In addition, after re-checking, when the step-out does not occur, the operation limit current value is returned to its original value, and while the value of the added M is maintained as it is, the drive current value is set to 113 mA in the EEPROM 26 (graph 9-5). In this case, the value of N is also returned to its original value.

In addition, in the description of the process measurement and the ordinary measurement, the motor rotation speed that may generate a step-out was 651 pps corresponding to 300 dpi×300 dpi to operate the stepping motor 15. However, not only one rotation speed, but plural motor rotation speeds may be used for the measurement. This is because the set drive current value is changed due to the motor rotation speed, that is, the drive frequency. As the drive frequency increases, the set drive current value also increases. Therefore, after measurement is performed, for example, at the drive frequency of 651 pps, an additional checking operation may be performed at a drive frequency of equal to or more than 1303 pps that is substantially twice the drive frequency of 651 pps.

In addition, in the description of the ordinary measurement, by decreasing the operation limit current value by a unit (N=1), whether or not the step-out occurs is detected. When the step-out occurs, the value of the additional motor torque M is increased by a unit to re-set the drive current value. However, as the method of setting the drive current value, in addition to the above-mentioned example, there is another method. For example, there is proposed a technique in which, when the step-out occurs, the value of the additional motor torque M is not immediately increased by one unit, but 2N (+10 mA) is added thereto, to perform re-checking while the additional motor torque M is not increased by one unit.

In the above description, the value of N is set to “−5 mA”, and the value of M is set to “+15 mA”. However, the values may be suitably changed depending on the type or load on the stepping motor 15.

The above-mentioned stepping motor 15 was exemplified as the stepping motor 15 as the carriage motor of the scanner multi-function device. However, this can be used in the case of checking and setting drive currents of other stepping motors.

In addition, in the above-mentioned process measurement and the ordinary measurement, the unit of N for checking the operation limit current value is set to 5 mA, and the unit of M that is the additional motor torque to be added is set to 15 mA. However, this is only an example, and the values are not limited thereto. In addition, the values can be suitably changed depending on the applied type of the stepping motor and the driving apparatus.

In addition, in the above-mentioned process measurement or the ordinary measurement, the detection of the step-out is performed so that the mark (marking of the home position) of the original position cannot be detected. However, the detection may be performed by using an additional sensor for step-out detection. In addition, the detection of the step-out may be performed by using a reaction of the stepping motor to a given pulse signal.

In the embodiments, the CPU 23 performs measurement processing and generates a motor drive control signal, and the logic circuit 30a of the motor control circuit 30 receives the signal to enable the driving circuit 30b to drive the stepping motor 15. However, the logic circuit 30a of the motor control circuit may drive the stepping motor 15.

In addition, the operation flowchart of the process measurement of FIG. 6, and the operation flowchart of the ordinary measurement of FIG. 8 are only examples, and the invention is not limited to those cases.

In addition, the function of the processor can be implemented by a computer. In this case, a program including contents for processing the function that the stepping motor control apparatus must have is provided. By executing the program in the computer, the processing function is implemented by the computer. The program in which processing contents are described can be recorded onto a computer-readable recording medium. As the computer-readable recording medium, there are magnetic recording devices, optical disks, an optical magnetic recording medium, a semiconductor memory, and the like. As the magnetic recording device, there are a hard disk drive (HDD), a flexible disk (FD), a magnetic tape, and the like. As the optical disk, there are a digital versatile disk (DVD), a DVD-RAM, a compact-disk ROM (CD-ROM), a CD recordable/rewritable (CD-R/RW), and the like. As the optical magnetic recording medium, there are a magneto-optical (MO) disk, and the like.

In the case of distributing the program, for example, transportable recording media such as a DVD and a CD-ROM in which the program is recorded is sold. In addition, the program may be stored in a storage device of a server computer such that the program is transferred to other computers from the server computer through a network.

The computer for executing the program, for example, stores the program recorded in a transportable recording medium or the program transferred from the server computer, onto its storage device. In addition, the computer reads the program from its storage device and executes processing of the program. Otherwise, the computer may directly read the program from the transportable recording medium to execute processing of the program. Otherwise, the computer may sequentially execute processing of the program whenever the program is transferred from the server computer.

What is claimed is:

1. A method of reading an image by an image sensor, executed by an apparatus including:
a carriage to which the image sensor is mounted;
a stepping motor which rotates to move the carriage in a predetermined direction;
a storage unit which stores a current value that is supplied to the stepping motor for rotating the stepping motor, the storage unit storing an initial first current value; and
a sensor which detects whether or not the carriage is disposed at a predetermined position,
the method comprising:
a) reciprocating the carriage from the predetermined position in the predetermined direction by rotating the stepping motor to which a second current value smaller than the first current value that is stored in the storage unit is supplied; and
b) detecting whether or not the carriage after reciprocating is disposed at the predetermined position, by the sensor,
wherein, in the case where the sensor detects that the carriage after reciprocating is disposed at the predetermined position, when the image sensor reads an image, the first current value is supplied to the stepping motor, and
in the case where the sensor detects that the carriage after reciprocating is not disposed at the predetermined position, when the image sensor reads an image, a current value obtained by adding a third current value to the first current value is supplied to the stepping motor.

2. The method according to claim 1, wherein the first current value is determined by:
c) reciprocating the carriage from the predetermined position in the predetermined direction by the rotation of the stepping motor to which a fifth current value smaller than a fourth current value that is determined in advance is supplied;
d) detecting whether or not the carriage after reciprocating is disposed at the predetermined position by the sensor;
e) when the sensor detects that the carriage after reciprocating is disposed at the predetermined position, storing as the first current value a current value obtained by adding a seventh current value to a sixth current value smaller than the fifth current value, in the storage unit; and
f) when the sensor detects that the carriage after reciprocating is not disposed at the predetermined position, storing as the first current value a current value obtained by adding the seventh current value to the fourth current value, in the storage unit.

3. The method according to claim 2, wherein the seventh current value is a fixed current value.

4. The method according to claim 3, wherein the third current value is a variable current value.

5. The method according to claim 2, wherein a rotation speed of the stepping motor in a) and a rotation speed of the stepping motor in c) are substantially the same.

6. An apparatus for reading an image by using an image sensor, comprising:
a carriage to which the image sensor is mounted;
a stepping motor which rotates to move the carriage in a predetermined direction;
a storage unit which stores a current value that is supplied to the stepping motor for rotating the stepping motor; and
a sensor which detects whether or not the carriage is disposed at a predetermined position,
wherein the storage unit stores an initial first current value,
the stepping motor is supplied with a second current value smaller than the first current value that is stored in the storage unit to reciprocate the carriage from the predetermined position in the predetermined direction,
the sensor detects whether or not the carriage after reciprocating is disposed at the predetermined position,
in the case where the sensor detects that the carriage after reciprocating is disposed at the predetermined position, when the image sensor reads an image, the first current value is supplied to the stepping motor, and
in the case where the sensor detects that the carriage after reciprocating is not disposed at the predetermined position, when the image sensor reads an image, a current value obtained by adding a third current value to the first current value, is supplied to the stepping motor.
